(19) United States
(12) Patent Application Publication
(10) Pub. No.: US 2003/0187632 A1
(43) Pub. Date: Oct. 2, 2003

(54) Multimedia conferencing system

(76) Inventor: Barry J. Menich, South Barrington, IL (US)

Correspondence Address: MOTOROLA, INC., 1303 EAST ALGONQUIN ROAD, IL01/3RD, SCHAUMBURG, IL, 60196

(21) Appl. No.: 10/115,200

(22) Filed: Apr. 2, 2002

(51) Int. Cl. G06F 17/20

(52) U.S. Cl. 704/1

(57) ABSTRACT

A multimedia conferencing system (100) includes a computer (204) that is configured to generate a searchable digest of a multimedia conference by converting audio included in a multimedia conferencing session data stream to text (604), extracting text from presentation materials included in the multimedia conferencing session data stream (606), applying semantic analysis to the text in order to extract identifications of meaning that preferably take the form of Subject Action Object tuples (812), and associating the identifications of meaning with time indexes (610) that identify the time of appearance of the text underlying the identifications of meaning in the multimedia conferencing session data stream.

### FIELD OF THE INVENTION

The present invention relates to multimedia computing and communication systems.

### BACKGROUND OF THE INVENTION

The proliferation of personal computers in conjunction with the advent of the Internet has greatly enhanced business communication. An associated benefit of email is that stored emails serves as a record of business matters that users may from time to time refer to in order to refresh their recollection of some matter in which they are involved or to retrieve some needed piece of information.

The proliferation of broad band access to the Internet, coupled with the ever increasing power of personal computers sets the stage for more wide spread use of multimedia conferencing. In multimedia conferencing remotely situated groups or individuals are able to speak, and at the same time see each other and share presentation materials e.g., power point slides. Multimedia conferencing greatly facilitates cooperation between remotely situated persons, e.g., two groups of engineers that are collaborating on a development project.

Such multimedia conferencing may, to some extent, supplant the use of email. To the extent that multimedia conferencing replaces email, a problem that arises is in the locating and retrieval of information that was conveyed in a multimedia conference session. It would be overly time consuming to view substantial parts of a multimedia conference session in order to find mention of some fact that is being sought.

### BRIEF DESCRIPTION OF THE FIGURES

FIG. 1 is a block diagram of a multimedia conferencing system according to the preferred embodiment of the invention.

FIG. 2 is a block diagram of a multimedia conferencing node used in the multimedia conferencing system shown in FIG. 1 according to the preferred embodiment of the invention.

FIG. 3 is a functional block diagram of a program for extracting identifications of meaning from multimedia conferencing session data according to the preferred embodiment of the invention.

FIG. 4 is a functional block diagram of a presentation materials text extractor software component of the program shown in FIG. 3 according to the preferred embodiment of the invention.

FIG. 5 is a functional block diagram of a linguistic analyzer software component of the program shown in FIG. 3 according to the preferred embodiment of the invention.

FIG. 6 is a flow diagram of the program for extracting identifications of meaning from multimedia conferencing session data that is shown in FIG. 3 I block diagram form according to the preferred embodiment of the invention.

FIG. 7 is a flow diagram of presentation materials text extractor software component that is shown in FIG. 4 in block diagram form according to the preferred embodiment of the invention.

FIG. 8 is a flow diagram of the linguistic analyzer software component that is shown in block diagram form in FIG. 3 according to the preferred embodiment of the invention.

FIG. 9 illustrates an exemplary hidden markov model of a text fragment that is used in the linguistic analyzer shown in FIGS. 5, 8.

FIG. 10 is a flow diagram of a program for searching identification of meaning extracted by the program shown in FIG. 3.

FIG. 11 is a hardware block diagram of a computer that may be used in the multimedia conferencing node shown in FIG. 2

### DETAILED DESCRIPTION OF THE PREFERRED EMBODIMENTS

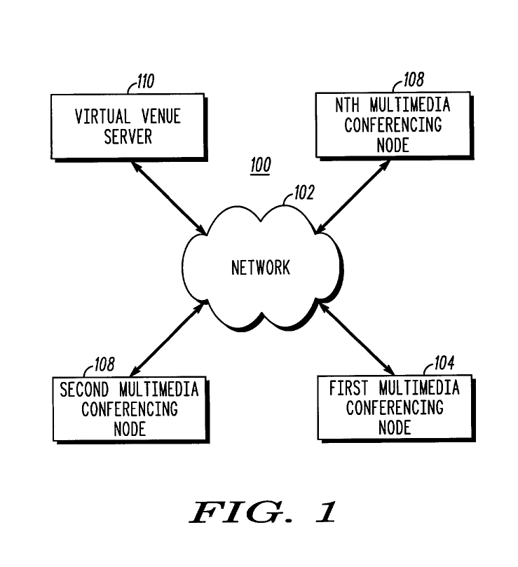

FIG. 1 is a block diagram of a multimedia conferencing system 100 according to the preferred embodiment of the invention. The system 100 comprises a network 102, through which multimedia conference data is transmitted. The network 102 may for example comprise the Internet or a Wide Area Network (WAN). A number of multimedia conferencing nodes including (as shown) a first multimedia conferencing node 104, a second multimedia conferencing node 106, and an Nth multimedia conferencing node 108 are communicatively coupled to the network 102. A virtual venue server 110 is also coupled to the network 102. The virtual venue server 110 which may run an Object Oriented Multi User Dimension (MOO) may be used for back channel communication by administrators managing a multimedia conference. Multimedia conference session data is communicated on a peer-to-peer basis between the multimedia conferencing nodes 104, 106, 108 using a multicasting protocol. In other words, each kth multimedia conferencing node sends out multimedia data generated from audio, and video inputs and presentation material sources at the kth node to other nodes in the system 100. The combined data rate, and volume of multimedia data produced in the course of an average length multimedia conference (say one hour) is very high. If this data is stored e.g., on a hard drive at one of the multimedia conferencing nodes, and it is desired at some latter date to review a mention of some particular topic, the task of searching through all of the multimedia data sequentially in order locate the particular topic would be daunting. The AccessGrid system developed by Argonne National Laboratory, a U.S. Department of Energy research institution, of Argonne Ill. is an established type of multimedia conferencing to which the invention may be adopted.

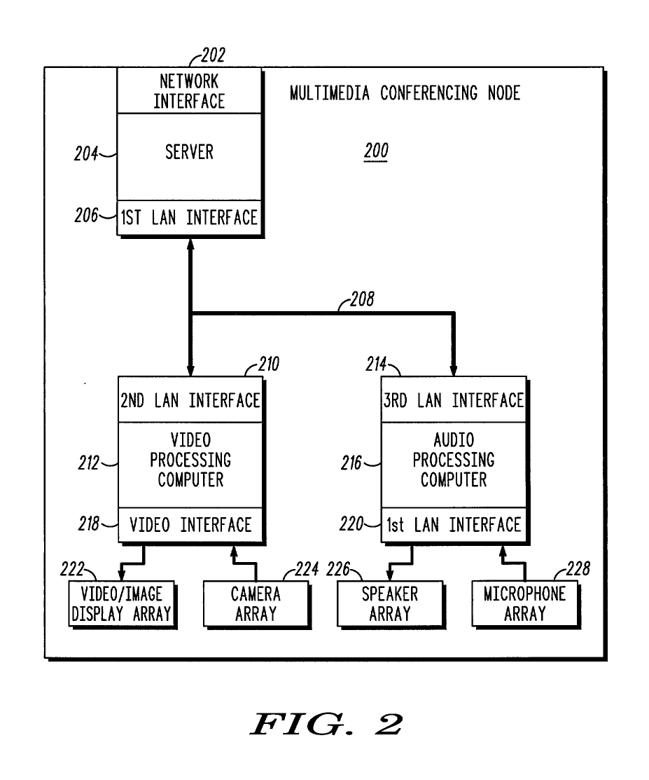

FIG. 2 is a block diagram of a multimedia conferencing node 200 used in the multimedia conferencing system 100 shown in FIG. 1 according to the preferred embodiment of the invention. Any or all of the three multimedia conferencing nodes 104, 106, 108 shown in FIG. 1 may have the internal structure shown in FIG. 2.

Referring to FIG. 2, the multimedia conferencing node 200 comprises a server 204, communicatively coupled to a network interface 202. The network interface 202 is used to couple the multimedia conferencing node 200 to the network 102 shown in FIG. 1. The server 204 is also communicatively coupled to a first Local Area Network (LAN) interface 206, that is in turn communicatively coupled to a LAN 208. Locally generated multimedia conference session data including digital representations of video, audio, and presentation materials passes out from the node 200 through the server 204 and the network interface 202, and multimedia conference session data from other nodes (e.g., digital representations of video, audio, and presentation materials) passes into the node 200 through the server 204 and the network interface.

A video processing computer 212 is communicatively coupled to the LAN 208 through a second LAN interface 210. The video processing computer 212 is communicatively coupled through a video interface 218 to a video/image display array 222, and to a camera array 224. The camera array serves as a video input. The video interface 218 may for example comprise one or more video driver cards, and one or more video capture cards (not shown). The video/image display array 222 may for example comprise Cathode Ray Tubes (CRT), projection displays, and/or plasma displays. The video/image display array 222 is used to display video, images and/or presentation materials that are included in the multimedia conference session data that is received from other multimedia conference nodes. The video/image display array 222 is preferably driven by one or more video driver cards included in the video interface 218. The camera array 224 may for example comprise a number of Charge Coupled Device (CCD) image sensor based video cameras. The camera array 224 is used to capture video of a scene at the conferencing node 200 including video of conference participants that is then transmitted to other multimedia conferencing nodes for display. Video and image compression and decompression may be handled by the video processing computer 212 or the video interface 218. The video processing computer 212 outputs, through the second LAN interface 210, a digital representation of video input through the camera array 224. The video conferencing computer 212 may also run parts of a communication protocol stack used to communicate through the second LAN interface 210. The video processing computer 212 may also be used to store and transmit presentation materials e.g., distributed PowerPoint (DPP) to other nodes. Distributed PowerPoint is an application for generating and presenting business presentation materials that is written by Microsoft Corporation of Redmond, Wash.

An audio processing computer 216 is communicatively coupled through a third LAN interface 214 to the LAN 208. The audio processing computer 216 is also coupled through an audio interface 220 to a speaker array 226, and a microphone array 228. Microphone array 228 is used as an audio input to input voices of conference participants located at the node 200, and the speaker array 226 is used to output the voices of conference participants that are located at other nodes. The audio interface 220 may for example comprise one or more sound cards, and echo cancellation hardware. The speaker array 226 is driven by the audio interface 220. Audio compression and decompression may be handled by the audio interface 220, or the audio processing computer 216. Decompression involves processing a digital representation of audio signal that includes a users voice in order to produce an audio signal that includes the users voice. Compression involves processing an audio signal that includes a users voice to produce a digital representation of the audio signal. The audio processing computer 216 outputs, through the third LAN interface 214, a digital representation of audio that is input through the microphone array 228.

Alternatively, rather than using separate computers 204, 212, 216 connected by the LAN, 208 a single more powerful computer may be used.

The multimedia conferencing node 200 may for example be located in a large conference room, that provides ample room for participants as well as the above described equipment.

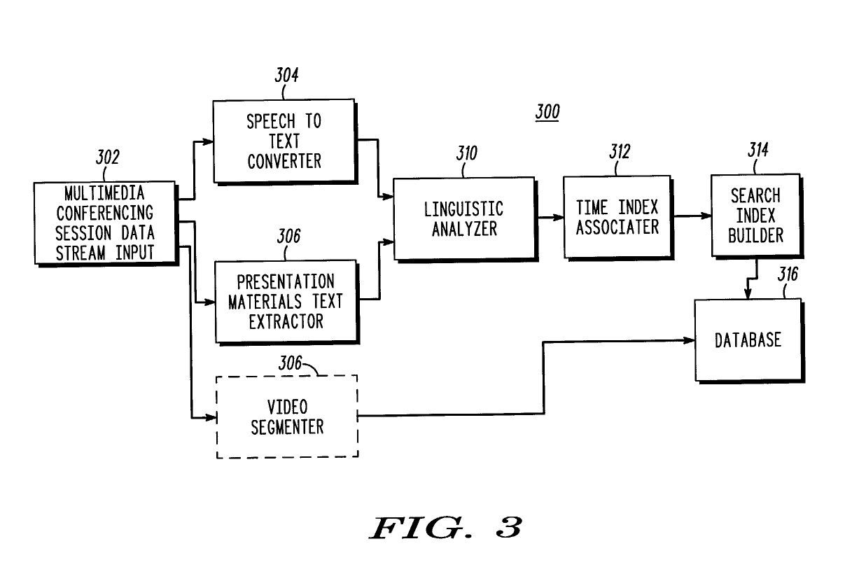

FIG. 3 is a functional block diagram of a program 300 for extracting identifications of meaning from multimedia conferencing session data according to the preferred embodiment of the invention. The program 300 is preferably run on the server 204, of the multimedia conferencing node 200. The program 300 need only be run at one node of the multimedia conferencing system 100. Referring to FIG. 3 block 302 is a multimedia conferencing session data input. The multimedia conferencing session data is preferably be read out sequentially from local storage (e.g., a hard drive) where it has been previously recorded.

A speech to text converter 304 receives audio included in the multimedia session data and converts speech that is included in the audio to text. Speech to text recognition software has reached a mature state of development and a number of software packages that may be used for block 304 are presently available. One such package is ViaVoice by International Business Machines of Armonk N.Y.

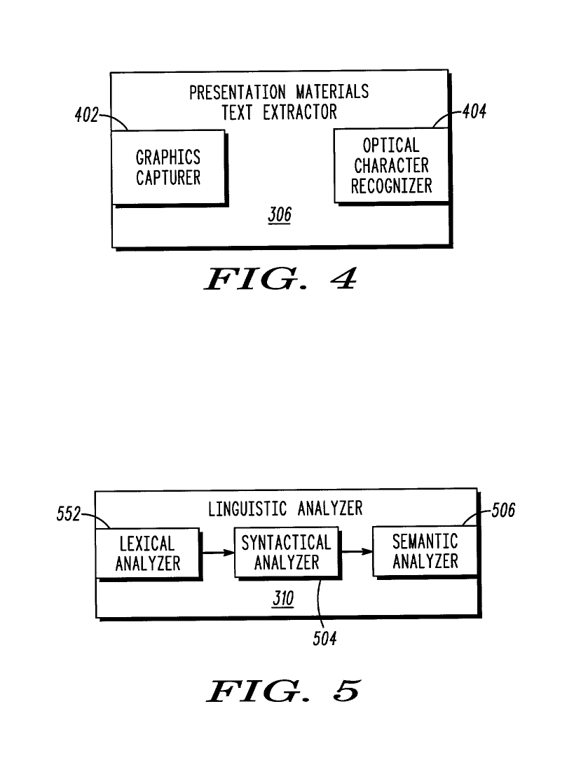

A presentation materials text extractor 306 receives presentation material files, e.g., slides and extracts text. A preferred form of the presentation material text extractor is described in more detail below with reference to FIG. 4.

An optional video segmenter 308 segments video included in the multimedia session data. The video segmenter if used preferably segments the video according to which of a plurality of speakers is speaking. Voice recognition software may be used to identify individual speakers.

Text output by the speech to text converter 304, and from the presentation material extractor 306 is input to a linguistic analyzer 310. The linguistic analyzer 310 preferably uses linguistic analysis that includes semantic analysis to extract identifications of meaning from the text it receives. The operation of the linguistic analyzer 310 is described in more detail below with reference to FIGS. 5, 8, 9. The linguistic analyzer 310 preferably outputs identifications of meanings from that text that take the form of Subject-Action-Object (SAO) tuples. Such SOA tuples are more indicative of information content than key words alone. A program called Knowledgist written by Invention Machine Corporation of Boston Mass. may be used to extract SAO tuples from a text.

A time index associater 312 receives SAO tuples output by the linguistic analyzer 310. The time index associater 312 adds a time index to each SAO tuple forming a time index SAO tuple. The time index associated with each kth SAO tuple is indicative of a time (absolute or relative e.g., to the multimedia conferencing session start) at which the text from which kth SAO tuple was derived, was communicated (e.g., uttered by a user or in the form of presentation materials.)

A search index builder 314 receives time index SAO tuples from the time index associater 312 and constructs a searchable digest that may be searched by SAO tuple in the course of information retrieval. The searchable digest is stored in a database 316 for future use.

FIG. 4 is a functional block diagram of the presentation materials text extractor software component 306 of the program 300 shown in FIG. 3 according to the preferred embodiment of the invention. As shown in FIG. 4 the presentation materials text extractor 306 comprises a graphics capturer 402 for capturing images of presentation materials, and an optical character recognizer 404 for extracting text that is included in the presentation materials. Various software vendors produce optical character recognition (OCR) software that may be used to implement the optical character recognizer 404. According to an alternative embodiment of the invention, text from certain types of presentation materials may be extracted through an associated program's Application Program Interface (API). For example text included in PowerPoint slides may be extracted through the PowerPoint (API).

FIG. 5 is a functional block diagram of the linguistic analyzer software component 310 of the program 300 shown in FIG. 3 according to the preferred embodiment of the invention. The linguistic analyzer 310 comprises a lexical analyzer 502, a syntactical analyzer 504, and a semantic analyzer 506.

The lexical analyzer 502 looks up words in text received from the speech to text converter 304, and presentation materials text extractor 306 in a dictionary which, rather than give meanings for words, identifies possible word classes for each word. Certain words can potentially fall into more than one word class. For example the word ‘plow’ may be a noun or a verb. Each word is associated by the lexical analyzer 502 with one or more word classes.

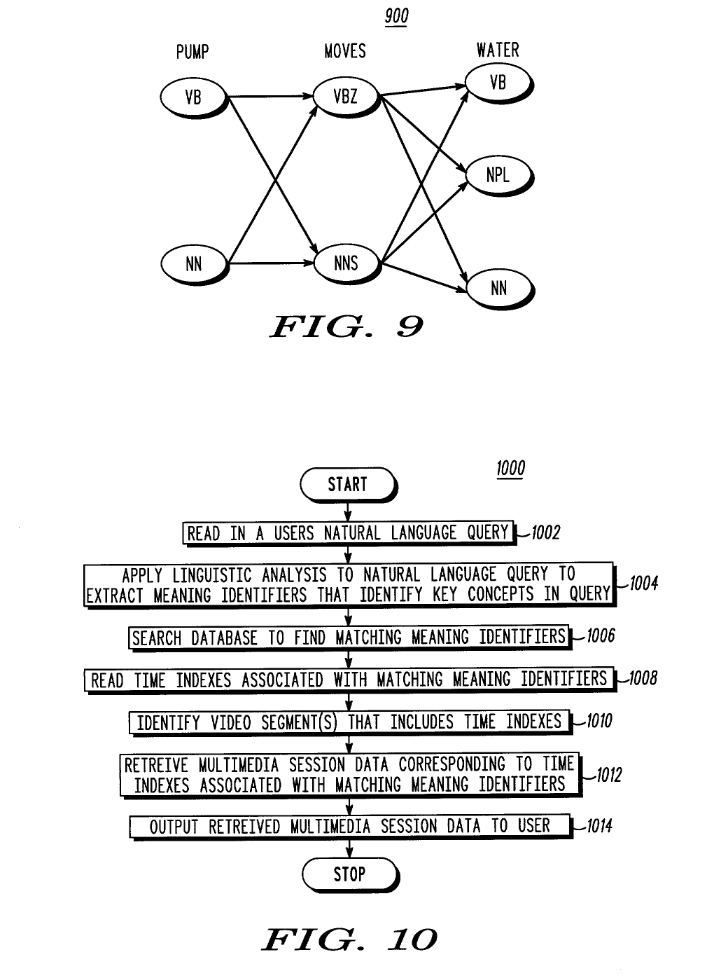

The syntactical analyzer 504 uses a hidden markov model (HMM) to make final selections as to the word class of each word. The HMM is described in more detail below with reference to FIG. 9. Optionally prior to applying the HMM, the syntactical analyzer 504 may apply known language syntax rules to eliminate certain possible word classes for some words.

Once word classes for each word have been selected, a semantic analyzer 506 picks out associated subjects, actions, and objects from at least some text fragments.

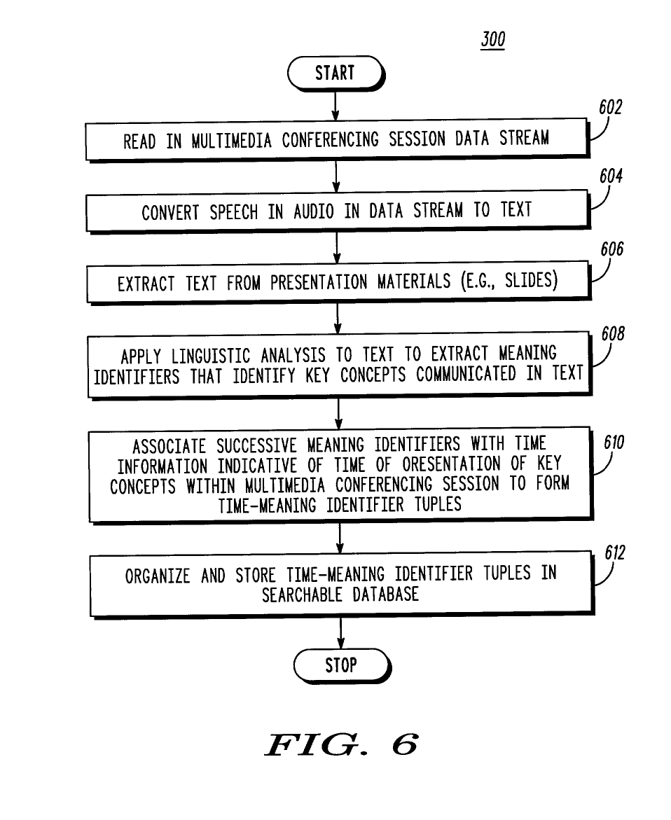

FIG. 6 is a flow diagram of the program 300 for extracting identifications of meaning from multimedia conferencing session data that is shown in FIG. 3 in block diagram form according to the preferred embodiment of the invention. Referring to FIG. 3 in step 602 a multimedia conferencing session data stream is read in. In step 604 speech included in audio that is included in the data stream is converted to text. In step 606 text is extracted from presentation materials (e.g., business graphics slides). In step 608 linguistic analysis is applied to the text extracted in the preceding two steps 604, 606 in order to extract meaning identifiers that identify key concepts communicated in the text. Step 608 is described in further detail above with reference to FIG. 5 and below with reference to FIGS. 8 and 9. In step 610 successive meaning identifiers extracted in step 608 are associated with time information, that is indicative of the time of occurrence within the multimedia conferencing session, so as to form time information-meaning identifier tuples. In step 612 the time information-meaning identifier tuples are organized and stored in the database 316 (FIG. 3). Such a database may be represented as a table that includes individual columns for the subject action and object parts of a SAO tuple and an additional column for an associated time index. Each row of the table would include a time index-SAO tuple. Such a table serves as a digest of the information content of a multimedia conferencing session.

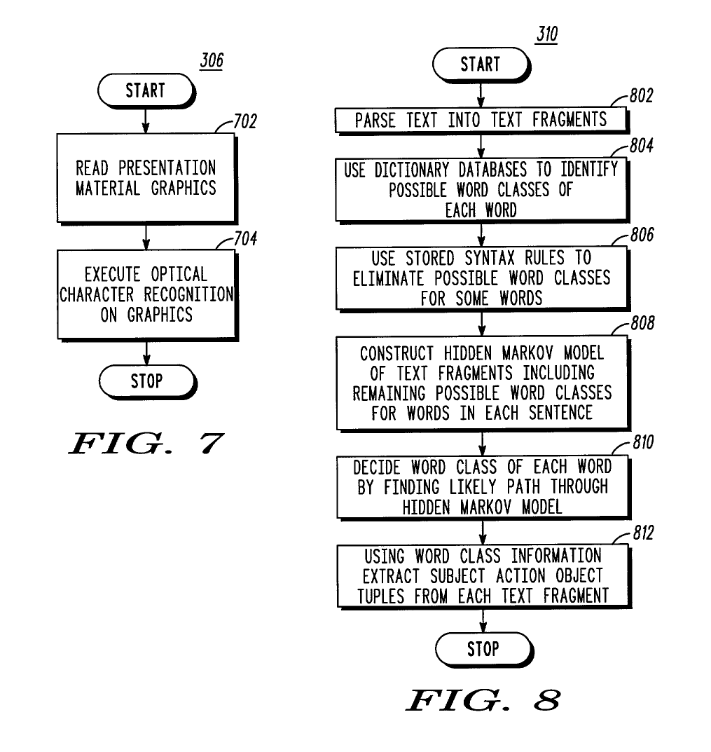

FIG. 7 is a flow diagram of the presentation materials text extractor software component 306 shown in FIG. 4 according to the preferred embodiment of the invention. Referring to FIG. 7, in step 702 presentation materials that are included in the multimedia conferencing session are read and in step 704 OCR is applied to extract text from the presentation graphics.

FIG. 8 is a flow diagram of the linguistic analyzer software component 310 shown in FIG. 3 according to the preferred embodiment of the invention. In step 802 text that is extracted from the multimedia session data is parsed into text fragments. For text extracted from presentation materials, parsing into text fragments may be done on the basis of included periods or text fragments can be identified as spatially isolated word sequences. In the case of text obtained from speech audio, parsing may be done by detecting long pauses (i.e. pauses of at least a predetermined length). In step 804 a dictionary database is used to identify one or more potential word classes for each word in the text. In step 806 (which is optional) stored syntax rules are used to eliminate possible word classes for certain words. In step 806 a HMM model of each text fragment is constructed.

FIG. 9 illustrates an exemplary hidden markov model 900 of a text fragment that is used in the linguistic analyzer 310 (FIGS. 3,5,8). The HMM shown in FIG. 9 corresponds to the text fragment “pump moves water”. The abbreviations used in FIG. 9 are defined as follows: VB=infinitive verb in its present simple tense form except 3^{rd} person singular, NN=common singular noun, VBZ=verb in its simple present 3^{rd} person singular tense form, NNS=common plural noun, NPL=capitalized locative noun singular. Other word types such as adjectives, personal pronouns, and prepositions would also be tagged as they appear in text fragments being processed. Each kth word in the fragment is represented in the HMM by one or more states that correspond to one or more possible word classes for the kth word. For example the word pump may be either a verb or a noun and so is represented by two possible states. In the HMM each word class and consequently each state is associated with an emission probability, furthermore each possible transition between word classes (e.g., noun to verb or noun to adjective) is also associated with a transition probability. The emission probabilities and the transition probabilities are determined statistically by analyzing a large volume of speech.

A path through the HMM includes exactly one state for each word. For example either VB or NN is included for the word ‘pump’ in each possible path through the HMM. An example of a path through the HMM would be NN-VBZ-NN (the correct path), another possible path is VB-NNS-NPL (an incorrect path). There are a number of possible alternative paths through the HMM. Each possible path through the HMM is associated with a probability that is the product of the emission probabilities of all the states in the path, and the transition probabilities of all the transitions in the path. A highly or most likely path through the HMM can be found using a variety of methods, including the Viterbi algorithm. When the correct path is chosen the word classes in that path for each word are taken as the correct word classes.

Referring again to FIG. 8, in step 810 the word class of each word is decided by finding the most likely path through the HMM constructed in the preceding step 808. In step 812 the word class information found in the preceding step is used to extract subject action object tuples from at lease some text fragments.

FIG. 10 is a flow diagram of a program 1000 for searching identifications of meaning extracted by the program shown in FIG. 3. In step 1002 a user's natural language query is read in. In step 1004 linguistic analysis of the type described above with reference to FIGS. 5, 8, 9 is applied to the user's query in order to extract meaning identifiers that identify key concepts in the query. The meaning identifiers extracted in step 1004 preferably take the form of SAO tuples. In step 1006 the database 316 (FIG. 3) is searched to identify matching meaning identifiers (preferably matching SAO tuples). A database of synonyms may be used to generalize or standardize the SAO tuples derived from the user's query or those included in the database. In step 1008 time indexes that are associated in the database 316 with matching meaning identifiers found in step 1006 are read from the database 316. In step 1010 video segments that include the time index are identified. Video included in the multimedia conferencing session data is optionally segmented by the segmenter 308 (FIG. 3). Alternatively, video may be segmented into fixed length segments without regard to video content or speaker identity. In step 1012 multimedia session data corresponding to the time indexes associated with the matching meaning identifiers (found in step 1006) is retrieved. The multimedia session data is stored on a memory medium accessible to the computer running the program 1000. In step 1014 the retrieved multimedia session data is output to the user. The program 1000 is an information retrieval program.

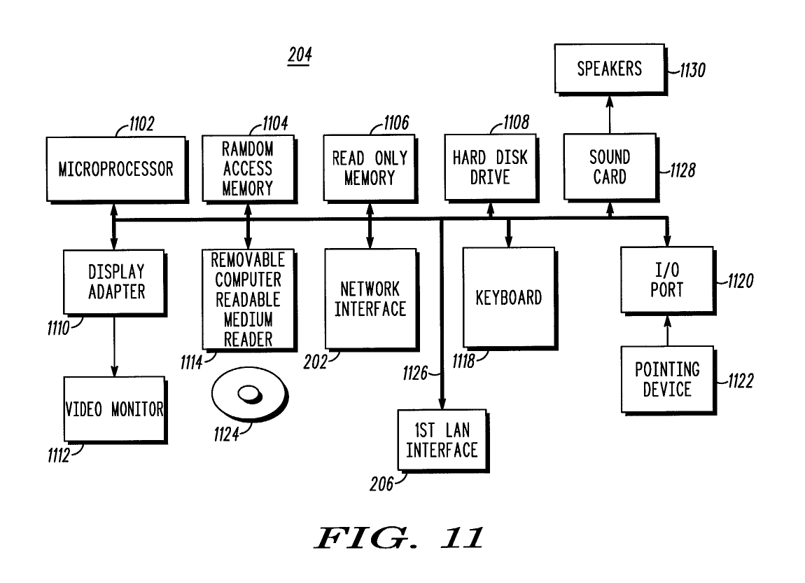

FIG. 11 is a hardware block diagram of the server 204 (FIG. 2). The server 204, or a computer of similar construction to which multimedia conferencing session data is transferred, is preferably used to execute the programs described above with reference to FIGS. 3-10. The server 204 comprises a microprocessor 1102, Random Access Memory (RAM) 1104, Read Only Memory (ROM) 1106, hard disk drive 1108, display adopter 1110 (e.g., a video card), a removable computer readable medium reader 1114, the network interface 202, the first LAN interface 206, keyboard 1118, sound card 1128, and an I/O port 1120 communicatively coupled through a digital signal bus 1126. A video monitor 1112 is electrically coupled to the display adapter 1110 for receiving a video signal. A pointing device 1122, preferably a mouse, is electrically coupled to the I/O port 1120 for receiving electrical signals generated by user operation of the pointing device 1122. One or more speakers 1130 are coupled to the sound card 1128. The computer readable medium reader 1114 preferably comprises a Compact Disk (CD) drive. A computer readable medium 1124 that includes software embodying the programs described above with reference to FIGS. 3-10 is provided. The software included on the computer readable medium 1124 is loaded through the removable computer readable medium reader 1114 in order to configure the server 204 to carry out processes of the current invention that are described above with reference to FIGS. 3-10. The server 1000 may for example comprise an IBM PC compatible computer.

As will be apparent to those of ordinary skill in the pertinent arts, the invention may be implemented in hardware or software or a combination thereof. Programs embodying the invention or portions thereof may be stored on a variety of types of computer readable media including optical disks, hard disk drives, tapes, programmable read only memory chips. Network circuits may also serve temporarily as computer readable media from which programs taught by the present invention are read.

While the preferred and other embodiments of the invention have been illustrated and described, it will be clear that the invention is not so limited. Numerous modifications, changes, variations, substitutions, and equivalents will occur to those of ordinary skill in the art without departing from the spirit and scope of the present invention as defined by the following claims.

What is claimed is:

1. A computer readable medium storing programming instructions for generating a digest of a multimedia conference, including programming instructions for:
reading in a multimedia conference data stream that includes an audio stream;
converting speech included in the audio stream to a first text;
performing linguistic analysis on the first text to extract a first sequence of meaning identifiers; and
associating a time index with each of the first sequence of meaning identifier to form a first set of time index-meaning identifier tuples.

2. The computer readable medium according to claim 1 wherein the programming instructions for performing linguistic analysis on the first text to extract a first sequence of meaning identifiers include programming instructions for: extracting sets of subjects actions and objects from the first text.

3. The computer readable medium according to claim 1 wherein the programming instructions for reading in the multimedia conference data stream include programming instructions for:
reading in a multimedia conference data stream that includes an audio stream and presentation materials; and
the computer readable medium further includes programming instructions for:
extracting a second text from the presentation materials;
performing linguistic analysis on the second text to extract a second sequence of meaning identifiers; and
associating a time index with each of the second sequence of meaning identifiers to form a second set of time index-meaning identifier tuples.

4. The computer readable medium according to claim 3 further comprising programming instructions for:
storing the first and second sets of time index time index meaning identifier tuples.

5. The computer readable medium according to claim 3 wherein the programming instructions for extracting a second text from the presentation materials include programming instructions for:
reading a graphic presentation material that includes text;
performing optical character recognition on the graphic presentation material.

6. The computer readable medium according to claim 1 wherein the programming instructions for performing linguistic analysis on the first text to extract a first sequence of meaning identifiers include programming instructions for:
parsing the first text into a sequence of text fragments each of which includes one or more words;
looking up the one or more words in a database to determine a set of possible word classes for the one or more words;
constructing a hidden markov model of each text fragment in which:
each kth word in the text fragment is represented by one or more states that correspond to possible word classes found in the database for the kth word;
each state is characterized by an emission probability that characterizes the probability of a corresponding word class appearing in the text fragment; and
states for successive words in the text fragment are connected by predetermined transition probabilities;
determining a highly likely path through the hidden markov model and thereby selecting a probable word class for each word;
identifying one or more sets of subjects, actions and objects from each text fragment.

7. The computer readable medium according to claim 6 wherein the programming instructions for performing linguistic analysis on the first text to extract a first sequence of meaning identifiers further comprises programming instructions for:
prior to constructing the hidden markov model, applying syntax rules to eliminate possible word classes for some words from each text fragment.

8. A multimedia conferencing system comprising:
a first multimedia conferencing node including:
a video input for capturing a video of a scene at the first multimedia conferencing node;
an audio input for inputting a user's voice;
one or more first computers that are:
coupled to the audio input and to the video input, wherein the one or more first computers serve to digitally process the video of the scene and the user's voice and produce a first digital representation of the user's voice and a second digital representation of the video of the scene at the first multimedia conferencing node;
a first network interface coupled to the one or more first computers for transmitting the first digital representation and the second digital representation;
a network coupled to the first network interface for receiving and transferring the first digital representation and the second digital representation;
a second multimedia conferencing node including;
a second network interface coupled to the network for receiving the first digital representation and the second digital representation;
a audio output device for outputting the users voice;
a video output device for outputting the video of the scene at the first multimedia conferencing node; and
a second computer coupled to the second network interface, wherein the second computer is programmed to:
receive the first digital representation and the second representation;
convert the user's voice to a first text;
extract a first sequence of meaning identifiers from the first text; and
associate one or more of the first sequence of meaning identifiers with timing information that is indicative of a relative time at which an utterance from which each meaning identifier was derived, was spoken by the user.

9. The multimedia conferencing system according to claim 8 wherein:
the second multimedia conferencing node comprises a one or more computers that are:
coupled to the second network interface, the audio output device and the video output device; and
programmed to:
process the first digital representation of the user's voice to derive an audio signal that includes the user's voice;
drive the audio output device with the audio signal;
process the second digital representation of the video of the scene to derive a video signal that includes the video of the scene; and
drive the video output device with the video signal.

10. The multimedia conferencing system according to claim 8 wherein:
the first multimedia conferencing node comprises a computer that is programmed to transmit presentation materials;
the second multimedia conferencing node comprises a computer that is programmed to receive the presentation materials;
extract a second text from the presentation materials;
extract a second sequence of meaning identifiers from the second text; and
associate one or more of the second sequence of meaning identifiers with timing information that is indicative of a relative time at which presentation materials, from which each of the second sequence of meaning identifiers were extracted, were presented.

11. The multimedia conferencing system according to claim 8 wherein the second computer is programmed to extract the first sequence of meaning identifiers from the text by:
parsing the first text into a sequence of text fragments each of which includes one or more words;
looking up the one or more words in a database to determine a set of possible word classes for the one or more words;
constructing a hidden markov model of each text fragment in which:
each kth word in the text fragment is represented by one or more states that correspond to possible word classes found in the database for the kth word;
each state is characterized by an emission probability that characterizes the probability of a corresponding word class appearing in the text fragment; and
states for successive words in the text fragment are connected by predetermined transition probabilities;
determining a highly likely path through the hidden markov model and thereby selecting a probable word class for each word;
identifying one or more sets of subjects, actions and objects from each text fragment.

12. A multimedia conferencing node comprising:
an input for inputting a multimedia conferencing session data stream;
a speech to text converter for converting speech that is included in audio that is included in the multimedia conferencing session data stream, to a first text.
a linguistic analyzer for extracting one ore more identifications of meaning from the first text; and
a time associater for associating time information with the one or more identifications of meanings thereby forming one or more time information-identification of meaning tuples.

13. The multimedia conferencing node according to claim 12 wherein the linguistic analyzer comprises:
a lexical analyzer for associating each of one or more words in the first text with one or more possible word classes;
a syntactic analyzer for selecting a particular word class from the one or more possible word classes that are associated with each of the one or more words;
a semantic analyzer for extracting subject action object tuples based on word class selections made by the syntactic analyzer.

14. The multimedia conferencing node according to claim 12 further comprising:
a presentation materials text extracter for extracting a second text from presentation materials that are included in the multimedia conferencing session data stream; and
wherein the linguistic analyzer also serves to extract one or more identifications of meaning from the second text.

15. The multimedia conferencing node according to claim 14 wherein the presentation material text extracter comprises:
a graphics capturer; and
an optical character recognizer.

16. A computer readable medium storing programming instructions for performing information retrieval on multimedia conferencing session data, including programming instructions for:
reading in a user's query;
searching a database to find meaning identifiers that match the user's query;
reading time indexes that are associated with meaning identifiers that match the user's query;
retrieving multimedia session data corresponding to time indexes that are associated with meaning identifiers that match the user's query.

17. The computer readable medium according to claim 16 wherein the programming instructions for:
reading in a user's query include programming instructions for:
reading in a natural language query; and
the computer readable medium further comprises programming instructions for:
prior to searching the database, applying linguistic analysis to the natural language query to extract meaning identifiers that identify key concepts in the query.
